(19) United States
(12) Patent Application Publication
(10) Pub. No.: US 2024/0357063 A1
(43) Pub. Date: Oct. 24, 2024

(54) COLOR WHEEL SYSTEM AND CONTROL METHOD OF COLOR WHEEL

(71) Applicant: Coretronic Projection (Kunshan) Corporation, Jiangsu (CN)

(72) Inventors: Xuchun Wang, Jiangsu (CN); Xijie Wang, Jiangsu (CN)

(73) Assignee: Coretronic Projection (Kunshan) Corporation, Jiangsu (CN)

(21) Appl. No.: 18/636,227

(22) Filed: Apr. 15, 2024

(30) Foreign Application Priority Data
Apr. 24, 2023 (CN) 202310447128.1

(51) Int. Cl. H04N 9/31; G02B 26/00; G03B 21/20

(52) U.S. Cl. CPC H04N 9/312; G02B 26/008; G03B 21/2033; H04N 9/3114

(57) ABSTRACT

A color wheel system and a control method of a color wheel are provided. The color wheel system includes a first driving circuit, a second driving circuit, and an image processing circuit. The first driving circuit and the second driving circuit are utilized for driving a first color wheel and a second color wheel, respectively. The image processing circuit is coupled to the first driving circuit and the second driving circuit. The image processing circuit is configured to provide first configuration information having address information of the first driving circuit to the first driving circuit and provide second configuration information having address information of the second driving circuit to the second driving circuit; provide a first adjustment signal to the first driving circuit and provide a second adjustment signal to the second driving circuit to respectively control rotation speeds of the first and second color wheels.

### CROSS-REFERENCE TO RELATED APPLICATION

This application claims the priority benefit of China application serial no. 202310447128.1 filed on Apr. 24, 2023. The entirety of the above-mentioned patent application is hereby incorporated by reference herein and made a part of this specification.

### BACKGROUND OF THE INVENTION

### Field of the Invention

The invention relates to a system and a method, and in particular to a color wheel system and a control method of a color wheel.

### Description of Related Art

Among today's projector techniques, laser projectors have gradually become one of the mainstream techniques used in the market. In laser projectors, generally speaking, a plurality of color wheels need to be disposed for projection display. Therefore, how to properly dispose the driving circuits for a plurality of color wheels has become one of the issues to be faced in the laser projector techniques.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY OF THE INVENTION

The invention provides a color wheel system and a control method of a color wheel that may reduce the cost of the color wheel system. Other objects and advantages of the invention may be further understood from the technical characteristics disclosed in the invention.

A color wheel system of the invention includes a first driving circuit, a second driving circuit, and an image processing circuit. The first driving circuit is utilized to drive a first color wheel according to a first drive signal. The second driving circuit is utilized to drive a second color wheel according to a second drive signal. The image processing circuit is coupled to the first driving circuit and the second driving circuit. The image processing circuit is configured to provide first configuration information having address information of the first driving circuit to the first driving circuit, and provide second configuration information having address information of the second driving circuit to the second driving circuit; and provide the first drive signal to the first driving circuit and provide the second drive signal to the second driving circuit to respectively control rotation speeds of the first color wheel and the second color wheel.

A control method of a color wheel of the invention is utilized to control a color wheel system including an image processing circuit, a first driving circuit, and a second driving circuit. The control method of the color wheel includes providing first configuration information having address information of the first driving circuit to the first driving circuit and providing second configuration information having address information of the second driving circuit to the second driving circuit via the image processing circuit; providing a first drive signal to the first driving circuit and providing a second drive signal to the second driving circuit via the image processing circuit; and controlling a rotation speed of a first color wheel according to the first configuration information and the first drive signal via the first driving circuit and controlling a rotation speed of a second color wheel according to the second configuration information and the second drive signal via the second driving circuit.

Based on the above, the color wheel system and the control method of the color wheel of the invention may reduce the cost of the color wheel system via the first driving circuit, the second driving circuit, the image processing circuit, and the coupling signal relationship thereof.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a color wheel system of an embodiment of the invention.

FIG. 2 is a top view of a layout of a color wheel system on a printed circuit board of an embodiment of the invention.

FIG. 3 is a schematic diagram of a color wheel system of an embodiment of the invention.

FIG. 4A is a flowchart of a control method of a color wheel of an embodiment of the invention.

FIG. 4B is a flowchart of a control method of a color wheel of an embodiment of the invention.

FIG. 5A is a flowchart of a boot-up method of an embodiment of the invention.

FIG. 5B is a flowchart of a shutdown method of an embodiment of the invention.

### DESCRIPTION OF THE EMBODIMENTS

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

The foregoing and other technical contents, features, and effects of the invention will be clearly presented in the following detailed description of a preferred embodiment with reference to the accompanying drawings. The directional terms mentioned in the following embodiments, such as: up, down, left, right, front, or back, etc., are only referring to the directions of the drawings. Accordingly, the directional terms are used to illustrate and not to limit the invention.

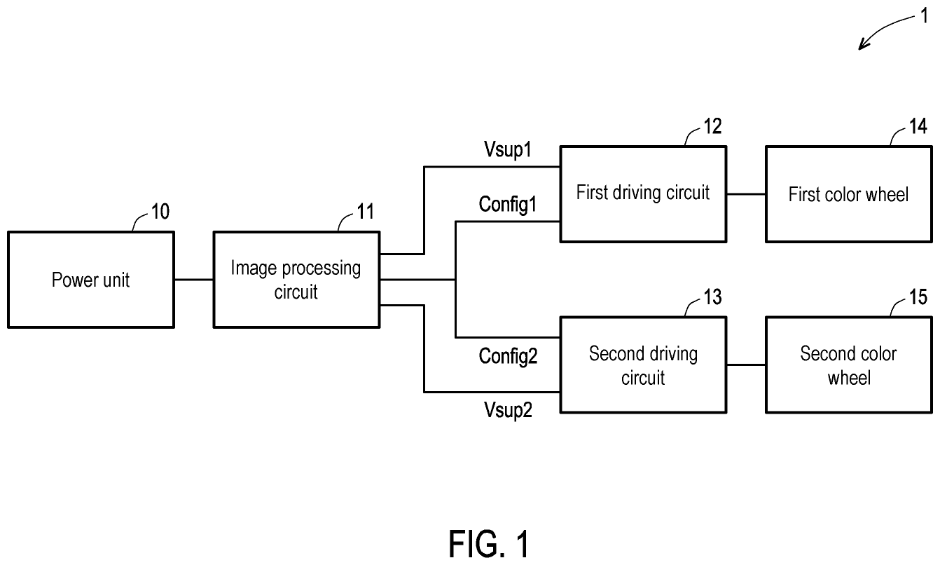

FIG. 1 is a schematic diagram of a color wheel system 1 of an embodiment of the invention. The color wheel system 1 includes a power unit 10, an image processing circuit 11, a first driving circuit 12, a second driving circuit 13, a first color wheel 14, and a second color wheel 15. The color wheel system 1 may be applied in a laser projector and used to control a plurality of color wheels in the laser projector. Further, the first color wheel 14 and the second color wheel 15 may be any one of a color wheel and a phosphor wheel, respectively. In some embodiments, the first color wheel 14 and the second color wheel 15 may be a color wheel and a phosphor wheel, respectively. The image processing circuit 11, the first driving circuit 12, and the second driving circuit 13 may be, for example, circuits formed by field-programmable gate array (FPGA) or by full custom technique or by combinational language. The first driving circuit 12 and the second driving circuit 13 may be used to drive the operation of the first color wheel 14 and the second color wheel 15 respectively. The image processing circuit 11 may provide a first drive signal Vsup1 and first configuration information Config1 to the first driving circuit 12 and provide a second drive signal Vsup2 and second configuration information Config2 to the second driving circuit 13 to control the driving of the first color wheel 14 and the second color wheel 15 by the first driving circuit 12 and the second driving circuit 13. In the color wheel system 1 shown in FIG. 1, regarding the power unit 10, the image processing circuit 11, the first driving circuit 12, and the second driving circuit 13, these plurality of driving circuits for driving the first color wheel 14 and the second color wheel may be disposed in the color wheel system 1 as independent and separate chips or integrated circuits, for example.

Specifically, in some existing implementations, the power conversion circuit and the driving circuit are integrated on the same modular chip. However, in some usage scenarios, when the color wheel system needs to be used to drive more than one color wheel at the same time, if the driving circuit and the power conversion circuit are bound on the same chip, the color wheel system needs to include a second modular chip to obtain the desired function of the second driving circuit. In this case, that is, when the power conversion circuit and the driving circuit are integrated on a single chip, the color wheel system needs to be configured with a corresponding number of modular chips in order to drive a plurality of color wheels. In this way, other power conversion circuits disposed in the modular chip are idle, resulting in waste of cost. Therefore, compared with the existing technique of integrating the power conversion circuit and the driving circuit in the same modular chip, in the embodiment, the power conversion circuit and the driving circuit are disposed on separate chips to effectively reduce the hardware cost of the color wheel system 1.

In detail, in the embodiment, the image processing circuit 11 is coupled to the first driving circuit 12 and the second driving circuit 13. The communication between the image processing circuit 11 and the first driving circuit 12 and the second driving circuit 13 may conform to Inter-Integrated Circuit (I²C) communication standard or Serial Peripheral Interface Bus (SPI) communication standard. More specifically, the first driving circuit 12 and the second driving circuit 13 may have the function of distinguishing chip address, so that the image processing circuit 11 may configure the first driving circuit 12 and the second driving circuit 13 via the address, so that the first driving circuit 12 and the second driving circuit 13 may drive the operation of the first color wheel 14 and the second color wheel 15 via the first drive signal Vsup1 and the second drive signal Vsup2 according to the set parameters thereof.

In some embodiments, the image processing circuit 11 may provide the first configuration information Config1 having the address information of the first driving circuit 12 to the first driving circuit 12 and provide the second configuration information Config2 having the address information of the second driving circuit 13 to the second driving circuit 13. In this way, the image processing circuit 11 may respectively set the registers (e.g., electronically erasable rewritable read-only memory) of the first driving circuit 12 and the second driving circuit 13 via the first configuration information Config1 and the second configuration information Config2 to set the operating parameters of the first color wheel 14 and the second color wheel 15. Specifically, the operating parameters of the first color wheel 14 and the second color wheel 15 may be respectively stored in the registers of the first driving circuit 12 and the second driving circuit 13, and the image processing circuit 11 may set the starting parameters such as starting voltage, starting current, and motor torque of the first driving circuit 12 and the second driving circuit 13 or related parameters such as voltage, current, and moment of inertia of the motor during normal operation when the first driving circuit 12 and the second driving circuit 13 are driving the first color wheel 14 and the second color wheel 15 via the first configuration information Config1 and the second configuration information Config2. For example, in some embodiments, before the color wheel system is started (such as when leaving the factory or before the machine is booted), the relevant information of the first configuration information Config1 and the second configuration information Config2 may be respectively disposed in the registers of the first driving circuit 12 and the second driving circuit 13 via the communication standard. In this way, when the image processing circuit 11 respectively provides the first drive signal Vsup1 and the second drive signal Vsup2 to the first driving circuit 12 and the second driving circuit 13, the first color wheel 14 and the second color wheel 15 may be driven according to the above settings. In another embodiment, when the color wheel system is in operation, the first configuration information Config1 and the second configuration information Config2 may also be respectively provided to the first driving circuit 12 and the second driving circuit 13 via the image processing circuit 11 for real-time adjustment.

In some embodiments, the power unit 10 is coupled to the image processing circuit 11. Although not shown in FIG. 1, the power unit 10 may receive and convert external power voltages to generate a plurality of driving voltages to the image processing circuit 11. The interior of the power unit 10 includes a plurality of voltage conversion circuits that may be utilized to receive the power voltage to generate a plurality of driving voltages respectively, and the voltage conversion circuit is, for example, an AC-DC conversion circuit including at least one element such as a switch element, an inductor, a capacitor, and a resistor. Specifically, each of the voltage converting circuits in the power unit 10 is operated independently to convert the power voltage into a plurality of DC voltages respectively. Since the voltage conversion circuit in the power unit 10 is operated independently, the power unit 10 may simultaneously output a plurality of DC voltages to the image processing circuit 11 according to requirements, so that the image processing circuit 11 may have greater flexibility in operation. For example, the DC voltage output by the power unit 10 may be, for example, at least three of 1.2 V, 1.8 V, 3.3 V, and 5 V, and the at least three output driving voltages may have different voltage values. Alternatively, among the at least three output driving voltages, two of the driving voltages may have the same voltage value, and the other driving voltages may have different voltage values from the first two.

In short, by disposing a plurality of internal driving circuits as independent and separate chips in the color wheel system 1, idling of the function of the integrated modular chip is avoided, so that the cost of the color wheel system 1 may be reduced. Moreover, the first driving circuit 12 and the second driving circuit 13 in the color wheel system 1 may have the function of distinguishing chip address, so that the image processing circuit 11 may provide the first configuration information Config1 and the second configuration information Config2 having address information to set the operating parameters for the first color wheel 14 and the second color wheel 15 stored in the memories of the first driving circuit 12 and the second driving circuit 13 respectively.

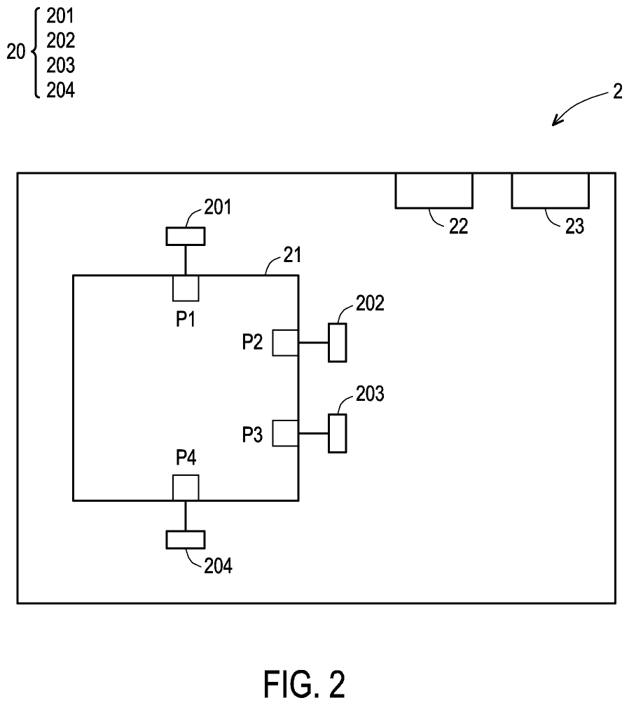

FIG. 2 is a top view of the layout of the embodiment of FIG. 1 on a printed circuit board of the invention. For the convenience of illustration, a color wheel system 2 shown in FIG. 2 omits some components, and only a power unit 20, an image processing circuit 21, a first driving circuit 22, and a second driving circuit 23 remain. The power unit 20 in the color wheel system 2 is formed by a plurality of voltage conversion circuits 201 to 204.

Specifically, the image processing circuit 21 in FIG. 2 is operated by receiving a plurality of driving voltages via a plurality of input ports P1 to P4, and the configuration position of the power unit 20 formed by the plurality of voltage conversion circuits 201 to 204 may be flexibly configured according to the plurality of input ports P1 to P4 of the image processing circuit 21. Therefore, the input ports are disposed at two sides of the image processing circuit 21 itself (for example, the input ports P1 and P4 are disposed at the upper and lower sides of the image processing circuit 21), the power unit 20 may be flexibly disposed at a position adjacent to the input ports P1 and P4 via the separate voltage conversion circuits 201 and 204, so that the image processing circuit 21 is disposed between the voltage conversion circuits 201 and 204, thereby reducing the wiring length and voltage drop of the color wheel system 2 and avoiding noise interference at the same time.

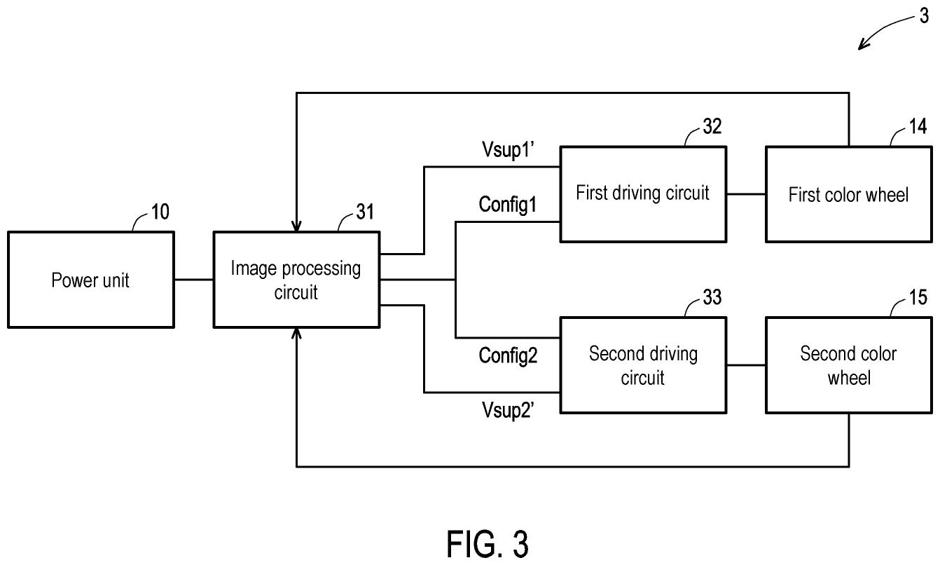

FIG. 3 is a schematic diagram of a color wheel system 3 of an embodiment of the invention. The color wheel system 3 of FIG. 3 is similar to the color wheel system 1 of FIG. 1. The difference between the two is that an image processing circuit 31 in the color wheel system 3 may sense the rotation speeds of the first color wheel 14 and the second color wheel 15 in real time and adjust the first drive signal Vsup1 and the second drive signal Vsup2 provided to the first driving circuit 32 and the second driving circuit 33 based on the real-time sensing result. Specifically, the first color wheel 14 and the second color wheel 15 may respectively provide rotation speed information to the image processing circuit 31, and the image processing circuit 31 may adjust the first drive signal Vsup1 and the second drive signal Vsup2 according to the rotation speed information and provide the adjusted first drive signal Vsup1 and second drive signal Vsup2 (that is, a first drive signal Vsup1′ and a second drive signal Vsup2′) to the first driving circuit 32 and the second driving circuit 33 to achieve the effect of fine-tuning the operations of the first color wheel 14 and the second color wheel 15.

Specifically, during the process of the image processing circuit 31 driving the first driving circuit 32 and the second driving circuit 33, in addition to adjusting the operating parameter settings of the first driving circuit 32 and the second driving circuit 33 via the first configuration information Config1 and the second configuration information Config2, the image processing circuit 31 may also monitor the real-time operation conditions of the first color wheel 14 and the second color wheel 15 and generate the adjusted first drive signal Vsup1 (i.e., the first drive signal Vsup1′) and the adjusted second drive signal Vsup2 (i.e., the second drive signal Vsup2′) according to the monitoring results to drive the first driving circuit 32 and the second driving circuit 33, so as to adjust the operations of the first color wheel 14 and the second color wheel 15. For example, the first drive signal Vsup1 and the second drive signal Vsup2 in FIG. 1 may be, for example, pulse width modulated signals, analog voltage signals, frequency signals, or signals conforming to Inter-Integrated Circuit (I²C) communication standard or Serial Peripheral Interface Bus (SPI) communication standard, and the image processing circuit 31 may adjust the first drive signal Vsup1 and the second drive signal Vsup2 via the monitoring results of the first color wheel 14 and the second color wheel and generate the signal characteristics of the first drive signal Vsup1′ and the second drive signal Vsup2′.

In this way, the color wheel system 3 may sense the rotation speeds of the first color wheel 14 and the second color wheel 15 via the image processing circuit 31 to generate the adjusted first drive signal Vsup1′ and the adjusted second drive signal Vsup2′, so as to adjust the driving characteristics of the first driving circuit 32 and the second driving circuit 33 on the first color wheel 14 and the second color wheel 15. Therefore, the overall driving process of the color wheel system 3 is improved. For example, in some embodiments, before the color wheel system is started (such as when leaving the factory or before the machine is booted), the relevant information of the first configuration information Config1 and the second configuration information Config2 may be respectively disposed in the registers of the first driving circuit 32 and the second driving circuit 33 via the communication standard. After the operation of the color wheel system 3 in this way, when the image processing circuit 31 respectively provides the first drive signal Vsup1 and the second drive signal Vsup2 (as shown in FIG. 1, for example, the default drive signal) to the first driving circuit 32 and the second driving circuit 33, the first color wheel 14 and the second color wheel 15 may be driven according to the above settings. Next, after the image processing circuit 31 receives the monitoring results of the first color wheel 14 and the second color wheel 15, the first drive signal Vsup1′ and the second drive signal Vsup2′ are adjusted and generated to the first driving circuit 32 and the second driving circuit 33, so as to adjust the first color wheel 14 and the second color wheel 15 in real time.

Although not explicitly shown in FIG. 3, the color wheel system 3 of FIG. 3 may also be applied to a dual image processing system. More specifically, the color wheel system 3 may further include an auxiliary image processing circuit in addition to the image processing circuit 31. The auxiliary image processing circuit may be coupled to a power unit, and when the image processing circuit 31 is used as the main controller to control the first color wheel 14 and the second color wheel 15, the auxiliary image processing circuit may be used as a slave controller to assist and accept the control and coordination of the master controller to operate the dual image processing system.

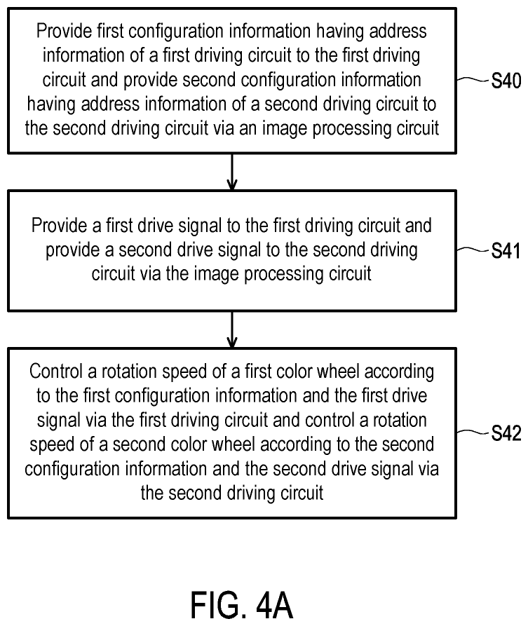

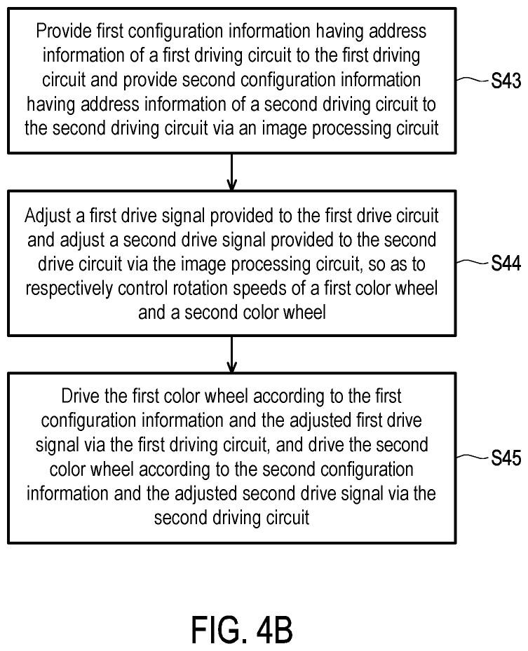

FIG. 4A is a flowchart of a control method of a color wheel of an embodiment of the invention. The control method of the color wheel shown in FIG. 4A may be applied to the color wheel system 1 of FIG. 1 or the color wheel system 3 of FIG. 3. The control method of the color wheel of FIG. 4A includes steps S40 to S42. In step S40, first configuration information having address information of a first driving circuit is provided to the first driving circuit and second configuration information having address information of a second driving circuit is provided to the second driving circuit via an image processing circuit. In step S41, a first drive signal is provided to the first driving circuit and a second drive signal is provided to the second driving circuit via the image processing circuit. In step S42, a rotation speed of a first color wheel is controlled according to the first configuration information and the first drive signal via the first driving circuit and a rotation speed of a second color wheel is controlled according to the second configuration information and the second drive signal via the second driving circuit.

It should be mentioned that, in step S40, the image processing circuit may provide the first configuration information having the address information of the first driving circuit to the first driving circuit and provide the second configuration information having the address information of the second driving circuit to the second driving circuit. The image processing circuit may respectively set the registers (such as electronically erasable rewritable read-only memory) of the first driving circuit and the second driving circuit via the first configuration information and the second configuration information, so as to control the operating parameters of the first color wheel and the second color wheel. Specifically, the operating parameters of the first color wheel and the second color wheel may be respectively stored in the registers of the first driving circuit and the second driving circuit, and the image processing circuit may set the starting parameters such as starting voltage, starting current, and motor torque of the first driving circuit and the second driving circuit or related parameters such as voltage, current, and moment of inertia of the motor during normal operation when the first driving circuit and the second driving circuit are driving the first color wheel and the second color wheel via the first configuration information and the second configuration information.

In other embodiments, in step S41, the image processing circuit may also provide the first drive signal to the first driving circuit and provide the second drive signal to the second driving circuit. For example, the first drive signal and the second drive signal may be, for example, pulse width modulation signals, analog voltage signals, frequency modulation signals, or signals conforming to Inter-Integrated Circuit (IC) communication standard or Serial Peripheral Interface Bus (SPI) communication standard. In this way, the first driving circuit may use the first drive signal as a power source to drive the first color wheel, and the second driving circuit may use the second drive signal as a power source to drive the second color wheel.

In other embodiments, in step S42, the first driving circuit may control the operation and the rotation of the first color wheel according to the first configuration information and the first drive signal, and the second driving circuit may control the operation and the rotation of the second color wheel according to the second configuration information and the second drive signal. In some embodiments, the first configuration information and the second configuration information may set various operation or activation parameters of the first color wheel and the second color wheel. In addition to being related to control parameters, the rotation speeds or the operations of the first color wheel and the second color wheel may also be related to the strengths of the first drive signal and the second drive signal. For example, the rotation speeds or the operations of the first color wheel and the second color wheel may be related to the voltage values, current values, signal pulse width lengths, duty cycles, and operating frequencies of the first drive signal and the second drive signal or other suitable information that may be carried in the first drive signal and the second drive signal. Therefore, the first color wheel and the second color wheel may be controlled by the first driving circuit and the second driving circuit at a suitable speed according to the first drive signal, the second drive signal, the first configuration information, and the second configuration information.

FIG. 4B is a flowchart of a control method of a color wheel of an embodiment of the invention. The control method of the color wheel shown in FIG. 4B may be applied to the color wheel system 1 of FIG. 1 or the color wheel system 3 of FIG. 3. The control method of the color wheel of FIG. 4B includes steps S43 to S45. In step S43, first configuration information having address information of a first driving circuit is provided to the first driving circuit and second configuration information having address information of a second driving circuit is provided to the second driving circuit via an image processing circuit. In step S44, a first drive signal provided to the first driving circuit and a second drive signal provided to the second driving circuit are adjusted via the image processing circuit to respectively control rotation speeds of a first color wheel and a second color wheel. In step S45, the first color wheel is driven according to the first configuration information and the adjusted first drive signal via the first driving circuit, and the second color wheel is driven according to the second configuration information and the adjusted second drive signal via the second driving circuit.

It should be mentioned that, in step S43, the image processing circuit may respectively set the registers (such as electronically erasable rewritable read-only memory) of the first driving circuit and the second driving circuit via the first configuration information and the second configuration information, so as to control the operating parameters of the first color wheel and the second color wheel. Specifically, the operating parameters of the first color wheel and the second color wheel may be respectively stored in the registers of the first driving circuit and the second driving circuit, and the image processing circuit may set the starting parameters such as starting voltage, starting current, and motor torque of the first driving circuit and the second driving circuit or related parameters such as voltage, current, and moment of inertia of the motor during normal operation when the first driving circuit and the second driving circuit are driving the first color wheel and the second color wheel via the first configuration information and the second configuration information.

In step S44, the image processing circuit may also monitor the real-time operation conditions of the first color wheel and the second color wheel to adjust the first drive signal provided to the first driving circuit and adjust the second drive signal provided to the second driving circuit, so as to fine-tune the driving of the first color wheel and the second color wheel for the first driving circuit and the second driving circuit. For example, the first drive signal and the second drive signal may be, for example, pulse width modulation signals, analog voltage signals, frequency signals, or signals conforming to Inter-Integrated Circuit (I²C) communication standard or Serial Peripheral Interface Bus (SPI) communication standard, and the image processing circuit may adjust any one or a plurality of signal characteristics above in the first drive signal and the second drive signal according to the monitoring results of the first color wheel and the second color wheel to achieve the effect of fine-tuning the operation of the first color wheel and the second color wheel.

In step S45, the first driving circuit may control the operation and the rotation of the first color wheel according to the first configuration information and the adjusted first drive signal, and the second driving circuit may control the operation and the rotation of the second color wheel according to the second configuration information and the adjusted second drive signal. In other embodiments, the first configuration information and the second configuration information may be set for various operation or activation parameters of the first color wheel and the second color wheel, and after setting, the color wheel system may also adjust the first drive signal and the second drive signal for driving according to the real-time monitoring results, thereby improving the driving operation of the first color wheel and the second color wheel. In other embodiments, a plurality of color wheels of the color wheel system may be activated and adjusted in real time by means of the control method of the color wheel shown in FIG. 4A and FIG. 4B.

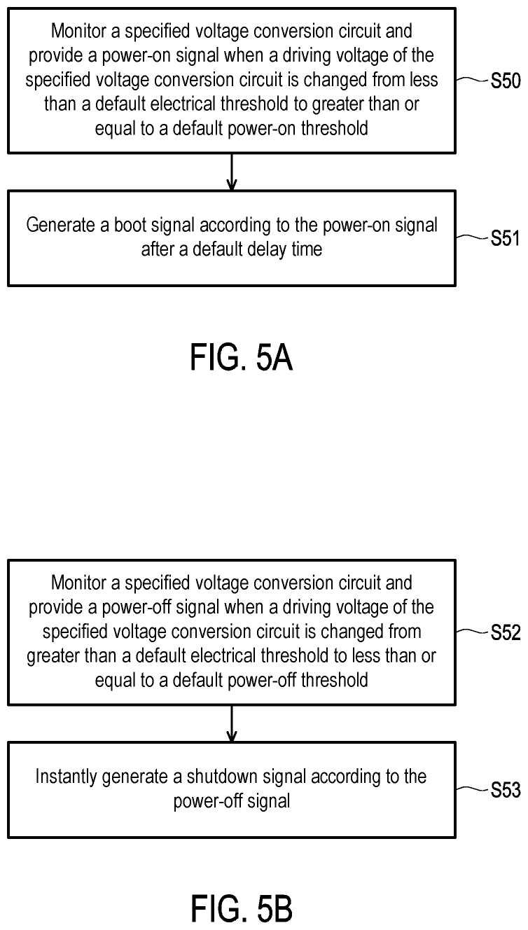

FIG. 5A is a flowchart of a boot-up method of an embodiment of the invention. The boot-up method in FIG. 5A may be applied to the color wheel system 1 of FIG. 1 or the color wheel system 3 of FIG. 3 to control the boot-up operation of the color wheel system. The boot-up method includes step S50 and step S51. In step S50, a specified voltage conversion circuit is monitored, and when a driving voltage of the specified voltage conversion circuit (such as the voltage output from the voltage conversion circuit to an image processing circuit) is changed from less than a default power-on threshold to greater than or equal to the default power-on threshold, a power-on signal is provided. In step S51, after a default delay time, a boot signal is generated according to the power-on signal.

Although not explicitly shown in FIG. 1 and FIG. 3, the color wheel system may also include a power monitoring circuit. The power monitoring circuit is coupled to a power unit. In step S50, the power monitoring circuit may monitor one or a plurality of driving voltages generated by the power unit. In some embodiments, the power monitoring circuit may monitor all of the driving voltages generated by the power unit and generate a power-on signal when each of the driving voltages exceeds the default power-on threshold. According to different design requirements, the default power-on thresholds used by the power monitoring circuit to compare with a plurality of driving voltages may be the same or different. In some embodiments, the power monitoring circuit may monitor the voltage conversion circuit generating the highest driving voltage in the power unit and send the power-on signal when the driving voltage generated by the voltage conversion circuit is changed to greater than or equal to the default power-on threshold. In some other embodiments, the power monitoring circuit may monitor the voltage conversion circuit generating the driving voltage latest in timing in the power unit, and send the power-on signal when the driving voltage generated by the voltage conversion circuit is changed to greater than or equal to the default power-on threshold.

In step S51, the power-on signal generated by the power monitoring circuit may be delayed by a default time and then provided to the controller of the projector or other suitable circuits, so that the projector configured by the color wheel system may perform a boot-up procedure accordingly. In some embodiments, during the default time when the power-on signal is delayed, the power monitoring circuit may continuously monitor the driving voltage to determine whether the driving voltage is always maintained at a voltage level greater than or equal to the default power-on threshold during this delay time to thereby determine whether the driving voltage is stable and may instruct the projector to perform a boot-up procedure. In some embodiments, the default time delay may be implemented by a delay circuit, and the delay circuit may be disposed independently or integrated into the power monitoring circuit.

FIG. 5B is a flowchart of a shutdown method of an embodiment of the invention. The shutdown method in FIG. 5B may be applied to the color wheel system 1 of FIG. 1 or the color wheel system 3 of FIG. 3 to control the shutdown operation of the color wheel system. The shutdown method includes steps S52 and S53. In step S52, a specified voltage conversion circuit is monitored, and a power-off signal is provided when a driving voltage of the specified voltage conversion circuit is changed from greater than a default power-off threshold to less than or equal to the default power-off threshold. In step S53, a shutdown signal is generated instantly according to the power-off signal.

In detail, in step S52, the color wheel system may use the power monitoring circuit to monitor one or a plurality of driving voltages generated by a power unit to generate the power-off signal. The default power-off threshold used by the power monitoring circuit may, for example, be the same as the default power-on threshold. In some embodiments, the default power-on threshold may be set to a higher voltage level, and the default power-off threshold may be set to a lower voltage level lower than the default power-on threshold. In this way, by setting a stricter default power-on threshold, the color wheel system may perform the boot-up procedure of the projector only after the driving voltage is stable. In addition, by setting the default power-off threshold in a looser voltage range acceptable to the system, the color wheel system may prevent the color wheel system and the projector from being readily shut down when the voltage is unstable to improve the stability of the system.

In step S53, when the power-off signal is generated, the monitored driving voltage is unstable, and the power monitoring circuit instantly provides the power-off signal to the controller of the projector or other suitable circuits, so that the color wheel system and the projector may start the shutdown procedure instantly, such as resetting the operating parameters to be written into the non-volatile memory and other operations, thus confirming that the projector and the color wheel system may be shut down properly.

Based on the above, the color wheel system and the control method of the color wheel of the invention may reduce the cost of the color wheel system by disposing a plurality of internal driving circuits in the color wheel system as independent and separate chips. Moreover, the first driving circuit and the second driving circuit in the color wheel system may have the function of distinguishing chip address, so that the image processing circuit may provide the first configuration information and the second configuration information having the address information to set the operating parameters for the first color wheel and the second color wheel stored in the memories of the first driving circuit and the second driving circuit respectively. Lastly, the image processing circuit in the color wheel system may sense the rotation of the first color wheel and the second color wheel in real time to provide a first adjustment signal and a second adjustment signal according to the sensing result to adjust the rotation of the first color wheel and the second color wheel respectively.

The above is only a preferred embodiment of the invention, and may not limit the scope of the invention. That is, all simple equivalent changes and modifications made in accordance with the claims of the invention and the content of the specification are still within the scope covered by the patent of the invention. In addition, any embodiment or claim of the invention need not achieve all the objects or advantages or features disclosed in the invention. In addition, the abstract of the specification and the title of the invention are only used to assist in the search of patent documents, and are not used to limit the patent scope of the invention. Moreover, terms such as “first” and “second” mentioned in this specification or claims are only used to name elements or distinguish different embodiments or ranges, and are not intended to limit the upper limit or the lower limit on the number of elements.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A color wheel system, wherein the color wheel system comprises a first driving circuit, a second driving circuit, and an image processing circuit, wherein,
the first driving circuit is utilized to drive a first color wheel according to a first drive signal;
the second driving circuit is utilized to drive a second color wheel according to a second drive signal; and
the image processing circuit is coupled to the first driving circuit and the second driving circuit, and the image processing circuit is configured to:
provide first configuration information having address information of the first driving circuit to the first driving circuit and provide second configuration information having address information of the second driving circuit to the second driving circuit; and
provide the first drive signal to the first driving circuit and provide the second drive signal to the second driving circuit to control a rotation speed of the first color wheel according to the first configuration information and the first drive signal and to control a rotation speed of the second color wheel according to the second configuration information and the second drive signal.

2. The color wheel system of claim 1, wherein the first configuration information and the second configuration information conform to Inter-Integrated Circuit (I²C) communication standard or Serial Peripheral Interface Bus (SPI) communication standard.

3. The color wheel system of claim 1, wherein the image processing circuit configures registers of the first driving circuit and the second driving circuit respectively via the first configuration information and the second configuration information and in correspondence to operating parameters of the first color wheel and the second color wheel.

4. The color wheel system of claim 2, wherein the image processing circuit is further utilized to generate the adjusted first drive signal and the adjusted second drive signal according to a real-time sensing of the rotation speeds of the first color wheel and the second color wheel via the image processing circuit.

5. The color wheel system of claim 1, wherein the color wheel system further comprises a power unit,
the power unit is coupled between a power voltage and the image processing circuit, and the power unit comprises a plurality of voltage conversion circuits utilized to receive the power voltage to respectively generate a plurality of driving voltages to the image processing circuit, wherein the plurality of voltage conversion circuits are operated independently to convert the power voltage into a plurality of DC voltages respectively.

6. The color wheel system of claim 5, wherein the image processing circuit is disposed between one of the plurality of voltage conversion circuits and another of the plurality of voltage conversion circuits.

7. The color wheel system of claim 5, wherein the color wheel system further comprises an auxiliary image processing circuit, and the color wheel system is operated as a dual image processing system via the image processing circuit and the auxiliary image processing circuit.

8. A control method of a color wheel, wherein the control method of the color wheel is utilized to control a color wheel system comprising an image processing circuit, a first driving circuit, and a second driving circuit, and the control method of the color wheel comprises:
providing first configuration information having address information of the first driving circuit to the first driving circuit and providing second configuration information having address information of the second driving circuit to the second driving circuit via the image processing circuit;
providing a first drive signal to the first driving circuit and providing a second drive signal to the second driving circuit via the image processing circuit; and
controlling a rotation speed of the first color wheel according to the first configuration information and the first drive signal via the first driving circuit and controlling a rotation speed of the second color wheel according to the second configuration information and the second drive signal via the second driving circuit.

9. The control method of the color wheel of claim 8, wherein the first configuration information and the second configuration information conform to Inter-Integrated Circuit (I²C) communication standard or Serial Peripheral Interface Bus (SPI) communication standard.

10. The control method of the color wheel of claim 8, wherein the step of providing the first configuration information having the address information of the first driving circuit to the first driving circuit and providing the second configuration information having the address information of the second driving circuit to the second driving circuit via the image processing circuit comprises:
configuring registers of the first driving circuit and the second driving circuit respectively via the first configuration information and the second configuration information and in correspondence to operating parameters of the first color wheel and the second color wheel.

11. The control method of the color wheel of claim 8, wherein the control method of the color wheel further comprises:
generating an adjusted first drive signal and an adjusted second drive signal according to a real-time sensing of the rotation speeds of the first color wheel and the second color wheel via the image processing circuit.

12. The control method of the color wheel of claim 8, wherein the color wheel system also comprises a power unit comprising a plurality of voltage conversion circuits, and the control method of the color wheel further comprises generating a plurality of driving voltages to the image processing circuit respectively by receiving a power voltage from the plurality of voltage conversion circuits of the power unit, wherein the plurality of voltage conversion circuits are operated independently to convert the power voltage into a plurality of DC voltages respectively.
